(19) United States
(12) Patent Application Publication
(10) Pub. No.: US 2016/0251050 A1
(43) Pub. Date: Sep. 1, 2016

(54) Multi-Functional Footboard Support of a Motor Scooter

(71) Applicant: Bayerische Motoren Werke Aktiengesellschaft, Muenchen (DE)

(72) Inventor: Angelika WINKLER, Grasbrunn (DE)

(21) Appl. No.: 15/147,963

(22) Filed: May 6, 2016

Related U.S. Application Data
(63) Continuation of application No. PCT/EP2014/071748, filed on Oct. 10, 2014.

(30) Foreign Application Priority Data
Nov. 11, 2013 (DE) 10 2013 222 810.4

(51) Int. Cl. B62J 25/00; B62K 11/00; B60K 11/04; B62J 27/00

(52) U.S. Cl. CPC B62J 25/00; B62J 27/00; B62K 11/00; B60K 11/04; B62K 2202/00

(57) ABSTRACT

A multi-functional footboard support of a motor scooter has a receiving and/or protective function that extends beyond receiving the footboard. The protective function is guaranteed by at least one lateral impact protection element formed along the side of the support when viewed in the direction of travel. The element at least partially covers a lateral surface of the motor scooter.

### CROSS REFERENCE TO RELATED APPLICATIONS

This application is a continuation of PCT International Application No. PCT/EP2014/071748, filed Oct. 10, 2014, which claims priority under 35 U.S.C. §119 from German Patent Application No. 10 2013 222 810.4, filed Nov. 11, 2013, the entire disclosures of which are herein expressly incorporated by reference.

### BACKGROUND AND SUMMARY OF THE INVENTION

The invention relates to a multifunctional footboard support of a motor scooter which, in addition to merely providing fastening means of receiving the footboard, has further functions for receiving components such as radiators, cables and the like and for protecting vehicle component parts.

It is known from the prior art to use as a footboard support in motor scooters a welded steel tube construction. The welded steel tube construction extends over the vehicle length at least in the region of the footboard rests and, in some cases, also further up to a front support or frame part in the rear region of the vehicle. Plastics rests are positioned and fastened on the steel tube construction. Such steel footboard supports thus merely fulfill the object of providing a rest for and a fastening means of receiving the footboards on which the driver can place his or her feet. In this case, the weight of the steel tube construction is comparatively high.

The object on which the invention is based is therefore to provide a footboard support for a motor scooter which, in addition to the preceding object, performs further functions and has a lower weight by comparison with conventional footboard supports.

This and other objects are achieved according to the invention by a multifunctional footboard support for a motor scooter which has at least one function extending beyond that of purely receiving and fastening the footboard. In particular, an advantageous combination is to equip the footboard support with a protective function for internal component parts of the motor scooter, wherein, in an advantageous embodiment, the protective function is ensured by at least one lateral impact protector formed laterally on said footboard support as viewed in the direction of travel. This protector at least partially covers a lateral surface of the motor scooter. In the event of a crash, for example during a fall to the side, the introduction of force is applied to the lateral impact protector which, consequently, can be at least partially deformed and/or destroyed. However, the internal component parts behind it are protected and remain intact.

In an advantageous embodiment of the footboard support, provision is made for it to be formed from plastic (for example PA) and for the lateral impact protector to be integrally formed thereon. Plastic is much lighter by comparison with the steel constructions used hitherto. Moreover, it is possible, for example using an injection molding process, for further functions such as lateral impact protection to be integrated as well without extending the weight-intensive use of steel. In one embodiment for increasing stability, it is also contemplated to use fiber-reinforced plastic. The integral incorporation of the lateral impact protector further brings about a reduction in the assembly effort.

In one embodiment which is advantageous in terms of energy absorption capacity and stiffness, the lateral impact protector is formed by a plurality of honeycomb cells. It is advantageous here to have an arrangement of the honeycomb cells in which the open side thereof in each case points in the lateral direction, i.e. perpendicularly to the direction of travel. Furthermore, in a preferred embodiment of the invention, provision is made for the plurality of honeycomb cells to directly adjoin one another, resulting in an overall structure comparable to a honeycomb. The lateral impact protector replaces crash pads or crash bars screwed to the frame and used hitherto in the prior art. Component parts relevant to safety such as, for example, a battery housing in an electric scooter, can be installed behind the lateral impact protector. In one exemplary embodiment, the extent of the lateral impact protector is provided such that the entire lateral region of the motor scooter below the driver's feet is covered and protected.

As a further function of the multifunctional footboard support, provision is made in one embodiment of the invention for at least one receptacle to be provided in a central region of the footboard support for fastening and guiding through a cable harness of the motor scooter. In addition, or as an alternative, a second receptacle for holding a radiator of the motor scooter is provided in a front region. It is also possible, for example, for receptacles for cooling water hoses to be provided. In the prior art, a holder always had to be welded to the frame or support in order to fasten such component parts, whereas the embodiment according to the invention easily makes it possible, by injection molding, for the receptacles to be integrated into the plastic support as well.

In an advantageous embodiment, provision is further made for the footboard support to have ventilation ducts which extend completely through the footboard support in the direction of travel and thus allow cooling of component parts, for example electronic components, arranged behind the footboard support as viewed in the direction of travel. It is advantageous here that a flow introduction region of the ventilation ducts is formed in the region of the receptacle for holding the radiator. The radiator is installed right at the front as viewed in the direction of travel so as to achieve an optimum flow of relative wind against it. Introduction into the ventilation ducts therefore also takes place in this region. Irrespective of whether the drive takes the form of an electric motor or an internal combustion engine, a conventional water radiator is used to cool the motor/engine with cooling liquid.

Furthermore, in the case of the footboard support according to the invention, it is advantageous that it has fastening devices for fastening fairing parts, with the result that additionally welded-on holders become obsolete. For example, clip connections or undercuts for engaging around can be provided.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a side view of a motor scooter without its fairing having a schematically illustrated footboard support according to an exemplary embodiment of the invention.

### DETAILED DESCRIPTION OF THE DRAWINGS

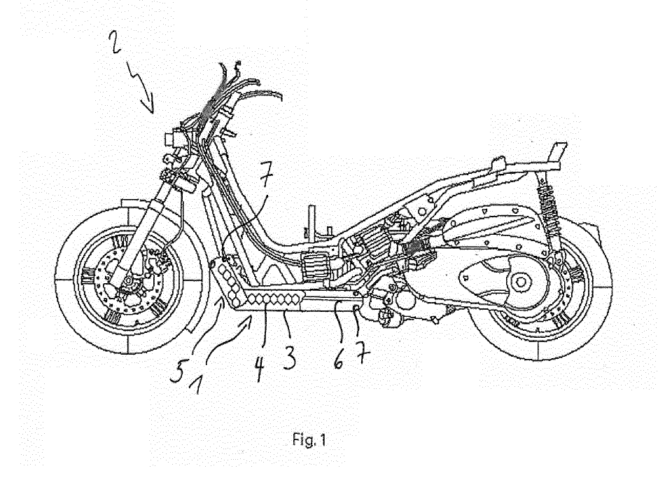

FIG. 1 schematically shows by way of example a motor scooter 2 having a footboard support 1, with no footboard rests being illustrated. The footboard support 1 is formed from glass-fiber-reinforced plastic and extends in the longitudinal direction from a region behind the front wheel to the swingarm. Provided in the front region 5 is an additional vertical portion which serves to receive a radiator and is arranged in a region exposed to the relative wind.

Over a predetermined vertical extent there is further provided, in the lateral region of the scooter 2, the lateral impact protector 3 which is formed by a plurality of honeycomb cells 4. The open side of the honeycomb cells 4 is in each case directed in the lateral direction, with the result that the force absorption capacity in the event of a lateral impact is increased. The honeycomb cells 4 directly adjoin one another, although the arrangement is not restricted to that shown. Rather, it is also possible for additional honeycomb cells 4 to be arranged among one another in order to achieve an overall structure comparable to a honeycomb.

Also provided on the footboard support 1 are air-guiding ducts 6 which extend completely through the footboard support 1 in the direction of travel and allow cooling of the component parts received in the footboard support 1 and of the components situated behind it in the direction of travel. The footboard support 1 also has indicated fastening devices 7 for fastening fairing parts. Further receptacles provided on the inside for cables, cooling hoses and the like are not explicitly illustrated, but likewise provided.

The invention is not restricted in its design to the preferred exemplary embodiments specified above. Rather, a number of variants which make use of the solution described are contemplated, even in embodiments which are of a fundamentally different kind. For example, it is also possible for component parts to be integrated on the footboard support on the outside in order to fulfill design functions or to receive technical component parts such as indicators or the like.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A component of a motor scooter, comprising:
a footboard support configured to receive a footboard;
at least one lateral impact protector that provides a protective function, the lateral impact protector being formed laterally on the footboard support as viewed in a direction of travel, wherein the lateral impact protector at least partially covers a lateral surface of the motor scooter.

2. The component according to claim 1, wherein the footboard support is formed of plastic and the lateral impact protector is integrally formed thereon.

3. The component according to claim 1, wherein the lateral impact protector comprises a plurality of honeycomb cells.

4. The component according to claim 3, wherein open sides of the plurality honeycomb cells point in a lateral direction perpendicular to the direction of travel.

5. The component according to claim 1, further comprising at least one receptacle provided in a central region of the footboard support, the receptacle being configured to fasten and guide through a cable harness of the motor scooter.

6. The component according to claim 5, further comprising at least one additional receptacle provided in a front region of the footboard support and being configured to hold a radiator of the motor scooter.

7. The component according to claim 1, further comprising at least one receptacle provided in a front region of the footboard support and being configured to hold a radiator of the motor scooter.

8. The component according to claim 1, further comprising one or more ventilation ducts configured to extend completely through the footboard support in the direction of travel.

9. The component according to claim 6, further comprising one or more ventilation ducts configured to extend completely through the footboard support in the direction of travel.

10. The component according to claim 9, wherein a flow introduction region of the one or more ventilation ducts is formed in a region of the additional receptacle for holding the radiator.

11. The component according to claim 1, further comprising fasteners configured to fasten fairing parts of the motor scooter.

12. A motor scooter, comprising:
a footboard support configured to receive a footboard;
at least one lateral impact protector that provides a protective function, the lateral impact protector being formed laterally on the footboard support as viewed in a direction of travel, wherein the lateral impact protector at least partially covers a lateral surface of the motor scooter; and
components of the motor scooter situated in a region of the footboard support, which components are arranged on an inner side of the lateral impact protector.

13. The motor scooter according to claim 12, wherein the footboard support is formed of plastic and the lateral impact protector is integrally formed thereon.

14. The motor scooter according to claim 12, wherein the lateral impact protector comprises a plurality of honeycomb cells.

15. The motor scooter according to claim 14, wherein open sides of the plurality honeycomb cells point in a lateral direction perpendicular to the direction of travel.

16. The motor scooter according to claim 12, further comprising at least one receptacle provided in a central region of the footboard support, the receptacle being configured to fasten and guide through a cable harness of the motor scooter.

17. The motor scooter according to claim 16, further comprising at least one additional receptacle provided in a front region of the footboard support and being configured to hold a radiator of the motor scooter.

18. The motor scooter according to claim 17, further comprising one or more ventilation ducts configured to extend completely through the footboard support in the direction of travel.

19. The component according to claim 18, wherein a flow introduction region of the one or more ventilation ducts is formed in a region of the additional receptacle for holding the radiator.
